(19) United States
(12) Patent Application Publication
(10) Pub. No.: US 2026/0093317 A1
(43) Pub. Date: Apr. 2, 2026

(54) CONTROL METHOD FOR MOTION EVALUATION SYSTEM, CONTROL METHOD FOR COMPUTER, NON-TRANSITORY COMPUTER-READABLE STORAGE MEDIUM STORING PROGRAM, AND MOTION EVALUATION SYSTEM

(71) Applicant: SEIKO EPSON CORPORATION, Tokyo (JP)

(72) Inventors: Fumikazu SANO, MATSUMOTO-SHI (JP); Shuji UCHIDA, SHIOJIRI-SHI (JP)

(73) Assignee: SEIKO EPSON CORPORATION, Tokyo (JP)

(21) Appl. No.: 19/337,933

(22) Filed: Sep. 24, 2025

(30) Foreign Application Priority Data
Sep. 27, 2024 (JP) 2024-168303

(51) Int. Cl. G06F 3/01

(52) U.S. Cl. CPC G06F 3/011

(57) ABSTRACT

According to an aspect of the present disclosure, there is provided a control method for a motion evaluation system including a sensor attached to a predetermined wearing position below a knee of a subject and a server device configured to generate an evaluation report based on a detection result of the sensor, the control method including a first step of causing the sensor to detect motion information indicating a motion below the knee of the subject, a second step of causing the sensor to transmit the motion information to the server device, a third step of causing the server device to estimate, based on the received motion information, timing when a foot of the subject came into contact with a target object, and a fourth step of causing the server device to perform evaluation concerning the estimated timing.

The present application is based on, and claims priority from JP Application Serial Number 2024-168303, filed September 27, 2024, the disclosure of which is hereby incorporated by reference herein in its entirety.

### BACKGROUND

### 1. Technical Field

The present disclosure relates to a control method for a motion evaluation system, a control method for a computer, a non-transitory computer-readable storage medium storing a program, and a motion evaluation system.

### 2. Related Art

In a motion performance monitoring system in a team competition environment described in JP-A-2017-74382, a kick of a player, who is subject of evaluation, is evaluated using a foot-worn sensor attached onto a foot of the player (see JP-A-2017-74382) .

JP-A-2017-74382 is an example of the related art.

However, in the related art explained above, when it is difficult to attach the sensor to the foot of the subject, the evaluation corresponding to timing when the foot of the subject has come into contact with the target object sometimes cannot be performed.

### SUMMARY

According to an aspect of the present disclosure, there is provided a control method for a motion evaluation system including a sensor attached to a predetermined wearing position below a knee of a subject and a server device configured to generate an evaluation report based on a detection result of the sensor, the control method including: a first step of causing the sensor to detect motion information indicating a motion below the knee of the subject; a second step of causing the sensor to transmit the motion information to the server device; a third step of causing the server device to estimate, based on the received motion information, timing when a foot of the subject came into contact with a target object; and a fourth step of causing the server device to perform evaluation concerning the estimated timing.

According to an aspect of the present disclosure, there is provided a control method for a motion evaluation system including a sensor attached to a predetermined wearing position below a knee of a subject and a server device configured to generate an evaluation report based on a detection result of the sensor, the control method including: causing the sensor to detect motion information indicating a motion below the knee of the subject; causing the server device to estimate, based on the received motion information, timing when a foot of the subject came into contact with a target object; and causing the server device to perform evaluation concerning the estimated timing.

According to an aspect of the present disclosure, there is provided a control method for a computer, the control method including: causing the computer to acquire motion information indicating a motion below a knee of the subject from a sensor attached to a predetermined wearing position below the knee of the subject; causing the computer to estimate, based on the acquired motion information, timing when a foot of the subject came into contact with a target object; and causing the computer to perform evaluation concerning the estimated timing.

According to an aspect of the present disclosure, there is provided a non-transitory computer-readable storage medium storing a program for causing the computer to execute the steps.

According to an aspect of the present disclosure, there is provided a motion evaluation system including: a sensor attached to a predetermined wearing position below a knee of a subject and configured to detect motion information indicating a motion below the knee of the subject; and a server device configured to receive the motion information from the sensor, estimate, based on the received motion information, timing when a foot of the subject came into contact with a target object, and perform evaluation concerning the estimated timing.

### BRIEF DESCRIPTION OF THE DRAWINGS

FIG. 1 is a diagram illustrating a configuration example of a motion evaluation system according to an embodiment.

FIG. 2 is a diagram illustrating a configuration example of a server device according to the embodiment.

FIG. 3A is a diagram illustrating a definition of a below-knee part according to the embodiment.

FIG. 3B is a diagram illustrating length of a below-knee part according to the embodiment.

FIG. 3C is a diagram illustrating an example of a first wearing position of a measurement device according to the embodiment.

FIG. 3D is a diagram illustrating an example of a second wearing position of the measurement device according to the embodiment.

FIG. 4 is a graph illustrating an example of a relationship between a body height and the below-knee length according to the embodiment.

FIG. 5 is a diagram illustrating a definition of a tilt angle of a foot according to the embodiment.

FIG. 6A is a diagram illustrating an example of a change in the posture of a human at the time of lifting according to the embodiment.

FIG. 6B is a diagram illustrating a graph representing an example of a relationship between an elapsed time and an angle of the foot at the time of lifting according to the embodiment.

FIG. 7 is a diagram illustrating an example of a procedure of processing performed by the server device according to the embodiment.

### DESCRIPTION OF EMBODIMENTS

An embodiment is explained below with reference to the drawings.

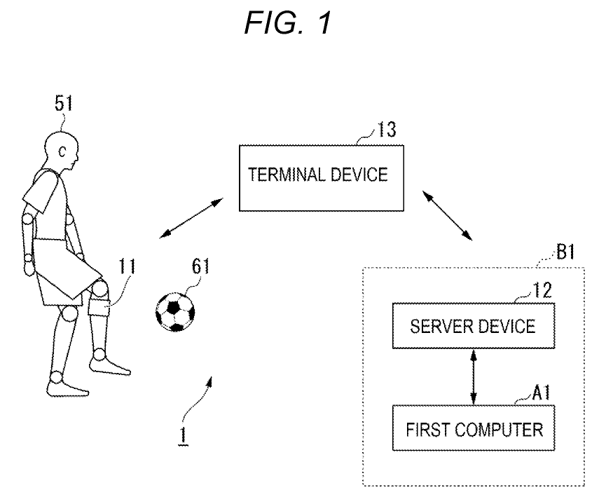

FIG. 1 is a diagram illustrating a configuration example of a motion evaluation system 1 according to the embodiment.

The motion evaluation system 1 includes a measurement device 11, a server device 12, a terminal device 13, and a first computer A1.

FIG. 1 illustrates a user 51 and a ball 61 lifted by the user 51.

In the example illustrated in FIG. 1, a management unit B1 including the server device 12 and the first computer A1 is illustrated.

Here, in the present embodiment, the measurement device 11 and the server device 12 communicate via the terminal device 13. However, for example, when the measurement device 11 and the server device 12 communicate without the terminal device 13, the terminal device 13 may not be provided in the motion evaluation system 1.

Although not illustrated in the example illustrated in FIG. 1, for example, the devices may communicate via a base station device, a relay device, or the like not illustrated in the figure.

In the present embodiment, for example, wireless communication is used as the communication. However, there may be a part where wired communication is used.

In the present embodiment, the first computer A1 capable of communicating with the server device 12 is provided. However, the first computer A1 may not always be provided.

In the example illustrated in FIG. 1, when the first computer A1 is not provided in the motion evaluation system 1, the management unit B1 is substantially equivalent to the server device 12.

Functions of the first computer A1 may be included in the server device 12.

The user 51 is a human and, in the present embodiment, is a child who plays soccer. In the present embodiment, the ball 61 is a soccer ball.

The measurement device 11 is attached to a predetermined wearing position below the knee of one leg of the user 51. The measurement device 11 may be attached to the wearing position of the user 51 using, for example, a band provided in the measurement device 11 or a band separate from the measurement device 11.

The user 51 may be called, for example, subject or player.

The measurement device 11 includes one or more sensors that detect a predetermined physical quantity.

The measurement device 11 may include, for example, an IMU sensor including an inertial measurement unit (IMU). The IMU sensor may measure, for example, an acceleration and an angular velocity.

The measurement device 11 and the terminal device 13 perform wireless communication.

In the present embodiment, the wireless communication may be Bluetooth (registered trademark) Low Energy wireless communication.

Here, the measurement device 11 may include any sensor and may include, for example, two or more sensors.

The measurement device may be called, for example, measurement instrument. For example, when the measurement device is equivalent to one sensor, the measurement device may be called sensor. For example, when the measurement device includes two or more sensors, the measurement device may be called sensor unit or the like.

The measurement may be called, for example, metering, detection, or sensing.

A value measured by the measurement device 11 may be called, for example, measurement value, detection value, or actual measurement value.

The terminal device 13 may be, for example, a smartphone, a tablet terminal, or a laptop computer.

The terminal device 13 and the server device 12 communicate via a network such as the Internet.

Here, as an example, the terminal device 13 may be held by a coach, a manager, a parent, or the like of the user 51.

The first computer A1 may be operated by a predetermined operator or the like.

The first computer A1 transmits, for example, user information, which is information concerning the user 51, to the server device 12.

The first computer A1 and the server device 12 communicate in a wired or wireless manner.

For example, all of the user 51, a person who operates the terminal device 13, and a person who operates the first computer A1 may be different persons, some of them may be the same person, or all of them may be the same person.

The server device 12 performs predetermined evaluation concerning a motion of the user 51.

In the present embodiment, schematically, the measurement device 11 transmits measurement data to the terminal device 13 and the terminal device 13 transmits the measurement data to the server device 12.

The server device 12 performs the predetermined evaluation concerning the motion of the user 51 based on the user information received from the first computer A1 and the measurement data received from the terminal device 13.

The server device 12 transmits the user information and an evaluation result to the terminal device 13.

The terminal device 13 displays the evaluation result received from the server device 12 on a screen. The terminal device 13 may also display the user information received from the server device 12 on the screen.

The terminal device 13 may control the measurement performed by the measurement device 11.

Here, in the present embodiment, for convenience of explanation, one user 51 is exemplified. However, for example, the motion evaluation system 1 according to the present embodiment may be applied to a plurality of users. In this case, the same processing as the processing in the present embodiment is performed for each of the users. In this case, information concerning each of the plurality of users may be, for example, stored as user information.

For example, when the motion evaluation system 1 is applied to a soccer class, the plurality of users may be children who take the soccer class.

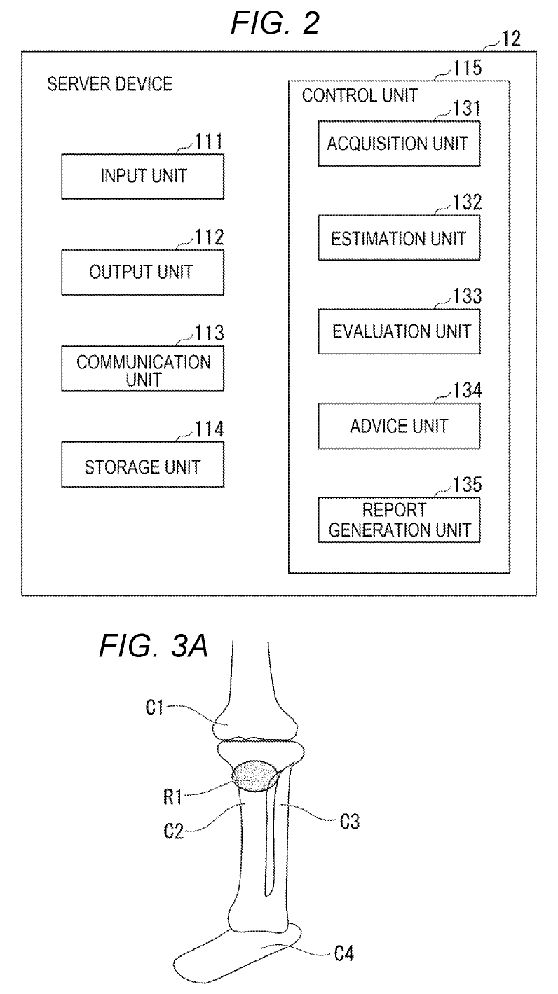

FIG. 2 is a diagram illustrating a configuration example of the server device 12 according to the embodiment.

In the present embodiment, the server device 12 is configured using a computer.

The server device 12 includes an input unit 111, an output unit 112, a communication unit 113, a storage unit 114, and a control unit 115.

The control unit 115 includes an acquisition unit 131, an estimation unit 132, an evaluation unit 133, an advice unit 134, and a report generation unit 135.

The input unit 111 may have, for example, a function of inputting information output from a not-illustrated external device.

When functions of the first computer A1 are incorporated in the server device 12, the input unit 111 may have a function of inputting, for example, an instruction based on operation performed by a not-illustrated operator or the like.

The output unit 112 may have, for example, a function of outputting information to the not-illustrated external device.

When the functions of the first computer A1 are incorporated in the server device 12, the output unit 112 may have, for example, a function of displaying and outputting information to be displayed on a not-illustrated display screen or a function of outputting sound information to a not-illustrated speaker.

The communication unit 113 has a function of performing communication.

In the present embodiment, the communication unit 113 communicates with the terminal device 13 via a network such as the Internet.

Note that, in the present embodiment, the communication unit 113 is illustrated separately from the input unit 111 and the output unit 112. However, for example, a function of a reception unit among functions of the communication unit 113 may be included in functions of the input unit 111 and a function of a transmission unit among the functions of the communication unit 113 may be included in functions of the output unit 112.

The storage unit 114 stores information.

Note that the server device 12 may be configured to, using a not-illustrated external database instead of the storage unit 114 or together with the storage unit 114, perform at least one of storing information in that database and acquiring information from that database.

The control unit 115 performs various kinds of processing or control in the server device 12.

In the present embodiment, the control unit 115 includes a predetermined processor such as a CPU (Central Processing Unit) and executes a control program with the processor to perform various kinds of processing or control.

The control program may be stored in, for example, the storage unit 114.

The acquisition unit 131 acquires data necessary for processing.

The acquisition unit 131 acquires, for example, data stored in the storage unit 114, data received by the communication unit 113, or data input by the input unit 111.

The data may be called information or the like instead.

The estimation unit 132 performs predetermined estimation. In the present embodiment, the estimation unit 132 may estimate, for example, a below-knee length, timing of ball touch, and speed of a foot. A value to be estimated may be calculated using, for example, a predetermined arithmetic expression. In this case, estimation processing is equivalent to arithmetic operation processing of the arithmetic expression. The arithmetic operation may be called, for example, computation or calculation.

The evaluation unit 133 performs predetermined evaluation. In the present embodiment, the evaluation unit 133 may perform, for example, evaluation concerning lifting at the time when the user 51 lifts the ball 61.

The advice unit 134 performs processing concerning predetermined advice. In the present embodiment, the advice is advice concerning an evaluation result.

The report generation unit 135 generates a predetermined report. In the present embodiment, the report is a report concerning the evaluation result and may include information concerning the advice.

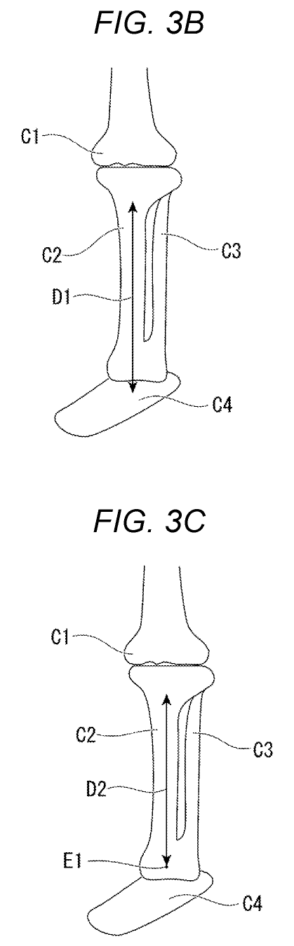

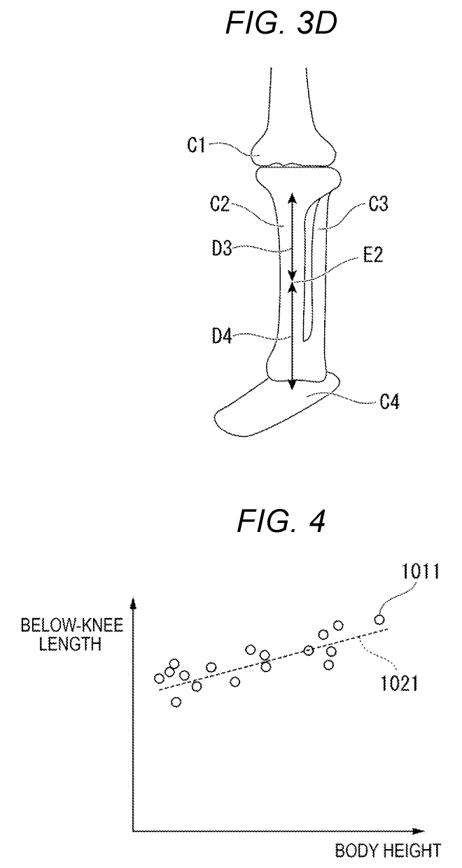

In the examples illustrated in FIGS. 3A to 3D, for convenience of explanation, a position closer to a foot with respect to the position of a human knee is referred to as lower side and a position closer to the knee with respect to the position of the foot is referred to as upper side.

FIG. 3A is a diagram illustrating a definition of a below-knee part according to the embodiment.

FIG. 3A illustrates, as a schematic bone structure in the vicinity of the human foot, a patella C1, a tibia C2 and a fibula C3 further on the lower side than the patella C1, and a tarsal C4 further on the lower side than the tibia C2 and the fibula C3.

In the present embodiment, a region of a below-knee part immediately below the knee is a region of the tibia C2 on the lower side of the patella C1 and not extending over the patella C1.

In the example illustrated in FIG. 3A, a first region R1, which is an example of the region of the below-knee part, is schematically illustrated. In the present embodiment, the position of one point included in the first region R1 is used as the position of the below-knee part.

In the present embodiment, as an example, the measurement device 11 is attached to a wearing position that is the position of the below-knee part.

FIG. 3B is a diagram illustrating the length from the below-knee part to the foot according to the embodiment.

Like FIG. 3A, FIG. 3B illustrates the patella C1, the tibia C2 and the fibula C3 further on the lower side than the patella C1, and the tarsal C4 further on the lower side than the tibia C2 and the fibula C3.

FIG. 3B illustrates a first length D1 equivalent to the length from the below-knee part to the foot in the present embodiment.

Here, in the present embodiment, the length from the below-knee part to the tarsal C4 is used as the length from the below-knee part to the foot.

In the present embodiment, the length from the below-knee part to the foot is also referred to as below-knee length.

FIG. 3C is a diagram illustrating an example of a first wearing position E1 of the measurement device 11 according to the embodiment.

Like FIG. 3A, FIG. 3C illustrates the patella C1, the tibia C2 and the fibula C3 further on the lower side than the patella C1, and the tarsal C4 further on the lower side than the tibia C2 and the fibula C3.

In the example illustrated in FIG. 3C, the first wearing position E1, which is a position above the foot is illustrated as another example of a position where the measurement device 11 is attached.

In the example illustrated in FIG. 3C, a second length D2 equivalent to the length from the below-knee part to the foot is illustrated.

Here, the position above the foot is, for example, the lower end of the tibia C2.

In the example illustrated in FIG. 3C, the measurement device 11 is attached above the foot and measures the speed of the foot. The speed at the first wearing position E1, which is a predetermined position below the knee, may be estimated from the speed of the foot and the length from the below-knee part to the foot.

FIG. 3D is a diagram illustrating an example of a second wearing position E2 of the measurement device 11 according to the embodiment.

Like FIG. 3A, FIG. 3D illustrates the patella C1, the tibia C2 and the fibula C3 further on the lower side than the patella C1, and the tarsal C4 further on the lower side than the tibia C2 and the fibula C3.

In the example illustrated in FIG. 3D, the second wearing position E2, which is the center position in the longitudinal direction of the tibia C2, is illustrated as another example of the position where the measurement device 11 is attached.

Further, in the example illustrated in FIG. 3D, a third length D3, which is the length from the second wearing position E2 to the below-knee part, and a fourth length D4, which is the length from the second wearing position E2 to the tarsal C4, are illustrated.

Here, the third length D3 and the fourth length D4 may be respectively regarded as, for example, a half of the length from the below-knee part to the foot.

In the example illustrated in FIG. 3D, the measurement device 11 is attached to the center position in the longitudinal direction of the tibia C2 and measures the speed at the position. The speed of the below-knee part may be estimated from the speed at the position and the third length D3. The speed of the foot may be estimated from the speed at the position and the fourth length D4.

FIG. 4 is a diagram illustrating a graph representing an example of a relationship between a body height and the below-knee length according to the embodiment.

In the graph, the horizontal axis represents the body height [cm] of a human and the vertical axis represents the below-knee length [cm] of the human.

In the graph, a plurality of round dots are a plurality of data points indicating results of actual measurement. In the example illustrated in FIG. 4, only one data point 1011 is denoted by a reference numeral for simplicity of illustration.

Further, the graph illustrates a first characteristic line 1021 that is a straight line based on a model formula obtained based on the plurality of data points.

In the present embodiment, the below-knee length can be estimated from the body height based on the first characteristic line 1021.

Here, the model formula is a model formula for estimating the below-knee length from the body height.

For example, the model formula may be acquired by collecting data representing a correspondence between the body height and the below-knee length and performing fitting of the least squares method or the like based on the data.

As an example, the model formula may be set as {(below-knee length) = (first value) × (body height) + (second value)}, and (first value) and (second value) may be calculated by linear approximation.

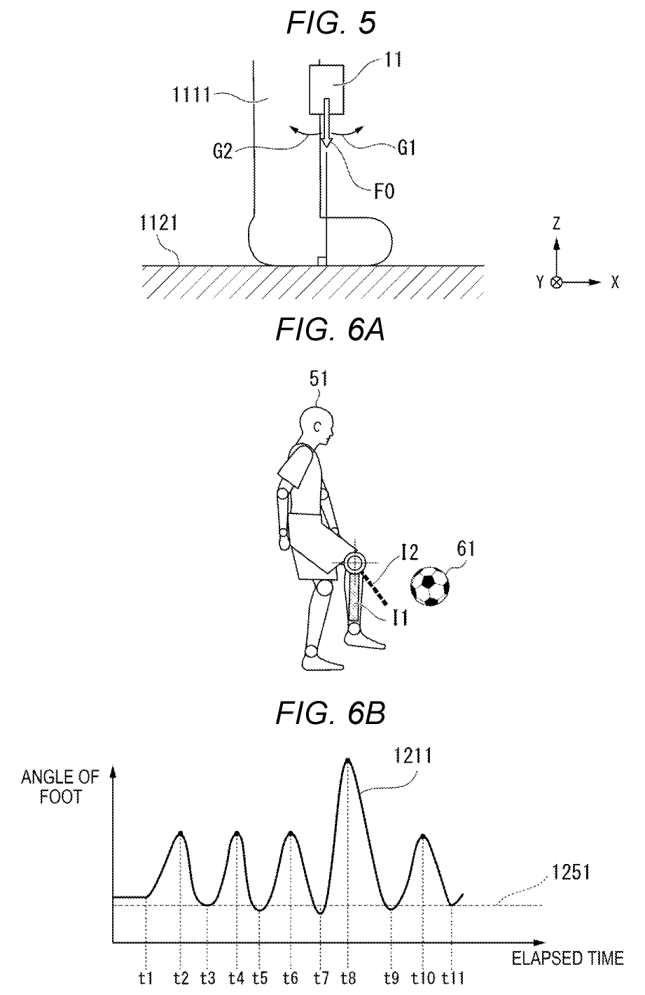

FIG. 5 is a diagram illustrating a definition of a tilt angle of the foot according to the embodiment.

FIG. 5 illustrates XYZ orthogonal coordinate axes, which are three-dimensional orthogonal coordinate axes, for convenience of explanation.

In this example, a direction from minus to plus of the X axis is a frontward direction and a direction from plus to minus of the X axis is a rearward direction. In this example, a direction from minus to plus of the Z axis is an upward direction and a direction from plus to minus of the Z axis is a downward direction and is a direction in which the gravity is applied.

FIG. 5 illustrates a leg 1111 including the lower leg and the foot further on the lower side than the human knee. The human is standing straight facing in the frontward direction and the foot is in contact with a ground 1121.

In the example illustrated in FIG. 5, the measurement device 11 is attached to a position in the frontward direction of the below-knee part. In this example, it is assumed that the measurement device 11 is fixed at a wearing position in the below-knee part.

In the example illustrated in FIG. 5, in a state in which the human is standing straight facing the frontward direction, a predetermined direction F0 vertically downward from a predetermined part of the measurement device 11 is set as a reference direction. That is, a state in which the predetermined direction F0 viewed from the measurement device 11 forms an angle of 90 degrees with respect to the ground 1121 is set as a reference.

When the human raises the foot in the frontward direction, the predetermined direction F0 tilts in the direction of a first tilt G1 and, in the present embodiment, the tilt is regarded as a tilt to the plus side with respect to 90 degrees.

Conversely, when the human raises the foot in the rearward direction, the predetermined direction F0 tilts in the direction of a second tilt G2 and, in the present embodiment, the tilt is regarded as a tilt to the minus side with respect to 90 degrees.

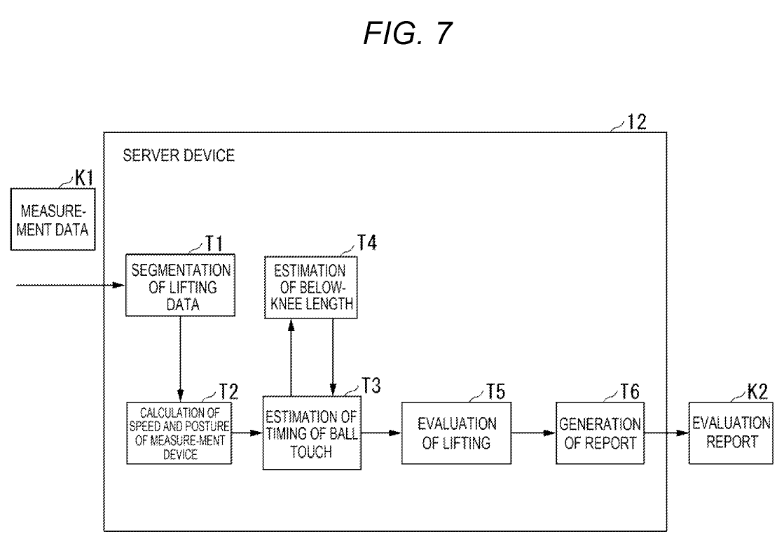

FIG. 6A is a diagram illustrating an example of a change in a posture of a human at the time of lifting according to the embodiment.

FIG. 6A illustrates a first posture I1 of the user 51 and a second posture I2 of the user 51 as examples of the posture of the human at the time of lifting.

In the example illustrated in FIG. 6A, angles of the foot are schematically different in the first posture I1 and the second posture I2 and the other body parts are illustrated in common.

When the user 51 lifts the ball 61, schematically, the user 51 performs a motion of repeating the first posture I1 and the second posture I2 in order.

In the example illustrated in FIG. 6A, the illustration is simplified and only a dotted line extending along the lower side of the knee is illustrated for the second posture I2. However, a schematic configuration further on the lower side than the knee in the second posture I2 is the same as a schematic configuration further on the lower side than the knee illustrated for the first posture I1.

In the first posture I1, in an up-down motion of the foot in the lifting, the user 51 lowers the foot and the ball 61 is not in contact with the foot.

In the second posture I2, in the up-down motion of the foot in the lifting, the user 51 lifts the foot and the ball 61 is in contact with the foot.

The first posture I1 and the second posture I2 are schematic exemplifications for explanation and, actually, the first posture I1 and the second posture I2 can vary every time the user 51 raises or lowers the foot.

The foot raising and lowering postures at the time of lifting illustrated in FIG. 6A are exemplifications for explanation and, for example, depending on each person, a posture at the time when the person raises the foot and the ball 61 comes into contact with the foot at the time of lifting and a posture at the time when the person lowers the foot and the ball 61 does not come into contact with the foot can be different.

FIG. 6B is a diagram illustrating a graph representing an example of a relationship between an elapsed time and an angle of the foot at the time of lifting according to the embodiment.

In the graph illustrated in FIG. 6B, the horizontal axis represents an elapsed time [second] and the vertical axis represents an angle of the foot [degree].

FIG. 6B illustrates a second characteristic 1211 representing a change in the angle of the foot at the time when the user 51 performs lifting.

FIG. 6B illustrates a first time t1 to an eleventh time t11 for the elapsed time on the horizontal axis.

The first time t1, the third time t3, the fifth time t5, the seventh time t7, the ninth time t9, and the eleventh time t11 respectively represent times when the foot of the user 51 is in or near the first posture I1.

The second time t2, the fourth time t4, the sixth time t6, the eighth time t8, and the tenth time t10 respectively represent times when the foot of the user 51 is in or near the second posture I2.

FIG. 6B illustrates a first straight line 1251 at the time when the angle of the foot is 90 degrees as a reference.

Here, theoretically, when the user 51 performs lifting, a motion in which the first posture I1 and the second posture I2 illustrated in FIG. 6A are repeated at a constant period is considered to be performed. However, actually, deviation can occur from such a motion.

In the example illustrated in FIG. 6B, the user 51 performing lifting includes a posture of lowering the foot deviating from the first posture I1, a posture of raising the foot deviating from the second posture I2, and a period of raising and lowering the foot not being a constant period.

In the present embodiment, predetermined evaluation is performed and a predetermined evaluation report is generated concerning the lifting performed by the user 51 not being a theoretical motion as explained above, in other words, concerning whether the user 51 has successfully performed a motion coinciding with or close to the theoretical motion when performing lifting.

FIG. 7 is a diagram illustrating an example of a procedure of processing performed by the server device 12 according to the embodiment.

In processing T1, the acquisition unit 131 acquires measurement data K1 and the estimation unit 132 segments data of lifting from the measurement data K1.

Here, as the data of lifting, data of, in a period of the measurement data K1, a period including a period in which the user 51 is estimated as having performed lifting is segmented. A method of segmenting the data of lifting is, for example, set in advance.

In processing T2, the estimation unit 132 calculates speed and a posture of the measurement device 11 for the segmented data of lifting.

In processing T3, the estimation unit 132 estimates timing of a ball touch by the foot of the user 51 based on a calculation result of the speed and the posture of the measurement device 11.

Here, the timing of the ball touch by the foot of the user 51 represents timing when the ball 61 comes into contact with the foot of the user 51.

In the present embodiment, the estimation unit 132 may calculate an angle of the foot of the user 51 and estimate the timing of the ball touch by the foot of the user 51 based on a result of the calculation.

In the present embodiment, the estimation unit 132 may calculate the speed of the foot in the direction of gravity of the user 51 and use a result of the calculation for evaluation of lifting. Besides the speed of the foot in the direction of gravity of the user 51, the estimation unit 132 may calculate the speed of the foot in a three-dimensional direction or the speed of the foot in a two-dimensional direction such as the front-rear and left-right directions and use a result of the calculation for evaluation of lifting.

In the present embodiment, the speed of the foot in the direction of gravity may be referred to as, for example, speed of the foot in the up-down direction.

At this time, for example, in processing T4, the estimation unit 132 may estimate the below-knee length of the user 51 based on the body height of the user 51.

Then, the estimation unit 132 may calculate the speed of the foot in the direction of gravity of the user 51 using the estimated below-knee length.

As another example, the estimation unit 132 may not perform the processing T4 when information concerning the below-knee length of the user 51 is acquired by the acquisition unit 131. That is, when the information concerning the below-knee length of the user 51 is used, for example, the information may be directly given or the information concerning the body height of the user 51 may be given and the below-knee length of the user 51 may be estimated based on the information.

In processing T5, the evaluation unit 133 evaluates lifting performed by the user 51. A method of evaluating lifting is, for example, set in advance.

In processing T6, the report generation unit 135 generates a predetermined evaluation report K2. At this time, the advice unit 134 may generate predetermined advice. The advice may be included in the evaluation report K2.

Here, a flow of entire processing performed in the motion evaluation system 1 according to the present embodiment is more specifically explained.

In the present embodiment, it is assumed that the measurement device 11 includes an IMU sensor.

In the present embodiment, it is assumed that the measurement device 11 is attached to the position of the below-knee part of the user 51. However, as another example, when the measurement device 11 is attached to another part below the knee, an arithmetic expression or the like to be used may be adjusted according to the part.

In preparation for measurement, information concerning the user 51 whose lifting is evaluated is input to the server device 12 from the first computer A1 using a Web browser.

Here, examples of the information concerning the user 51 include information such as a name and a birth date and, in the present embodiment, includes information concerning the body height. In the present embodiment, the below-knee length is estimated from the body height. However, when such estimation is not performed, the information concerning the body height may not be input to the server device 12.

The server device 12 stores the input information concerning the user 51 in the storage unit 114.

Processing for at the time of measurement is explained.

The user 51 wears the measurement device 11 at a predetermined part. In the present embodiment, the predetermined part is the position of the below-knee part.

Subsequently, the measurement device 11 worn by the user 51 starts measurement. Here, the measurement device 11 may start the measurement, for example, in response to reception of a predetermined instruction from the terminal device 13. The terminal device 13 may be operated by the user 51, the coach, or the like to transmit the predetermined instruction to the measurement device 11.

As another example, the measurement device 11 may be directly operated to start the measurement or the measurement device 11 may be configured to always perform the measurement.

At the time of the start of the measurement, for example, the measurement device 11 starts the IMU sensor and measures acceleration data and angular velocity data in every predetermined period. The predetermined period may be, for example, one millisecond. In this case, measurement is performed at 1 kHz.

The measurement device 11 stores data of a measurement result in a not-illustrated internal memory.

Subsequently, the user 51 performs a motion of lifting the ball 61. In this example, the user 51 repeatedly touches the ball 61 with the foot and lifts the ball 61 upward a plurality of times.

Thereafter, the measurement device 11 stops the measurement. Here, the measurement device 11 may end the measurement, for example, in response to reception of a predetermined instruction from the terminal device 13. The terminal device 13 may be operated by the user 51, the coach, or the like to transmit the predetermined instruction to the measurement device 11.

As another example, the measurement device 11 may be directly operated to end the measurement or the measurement device 11 may be configured to always perform the measurement and not to stop the measurement.

When stopping the measurement, the measurement device 11 stops the IMU sensor and ends the storage in the internal memory.

After ending the measurement, the measurement device 11 performs processing of transmitting measurement data K1, which is data of a measurement result, to the server device 12. Here, for example, in response to reception of a predetermined instruction from the terminal device 13, the measurement device 11 may perform processing of transmitting the measurement data K1 to the server device 12. The terminal device 13 may be operated by the user 51, the coach, or the like to transmit the predetermined instruction to the measurement device 11.

In the present embodiment, the measurement device 11 uploads the measurement data K1 to the terminal device 13 and the terminal device 13 uploads the measurement data K1 to the server device 12 by the Internet communication or the like.

The server device 12 analyzes the uploaded measurement data K1 and transmits data of a result of the analysis to the terminal device 13.

The terminal device 13 displays the data of the result on a screen. Accordingly, the user 51, the coach, or the like can view the data of the result.

Here, the data of the result includes, for example, an evaluation result of lifting.

Concerning the processing of evaluation of lifting performed by the server device 12, the processing illustrated in FIG. 7 is explained more in detail.

In the processing T1 illustrated in FIG. 7, the server device 12 segments target data of lifting in a predetermined time from the received measurement data K1.

The segmentation of the data of lifting in the predetermined time is performed by, for example, the following procedures P1 to P2.

In the procedure P1, the server device 12 views from the start of the measurement data K1 and determines, as a point of a start of lifting, a point where the difference in the norm of angular velocities of three axes exceeds a predetermined threshold. That is, when the foot hits the ball 61, the rotation of the foot is decelerated. The rotation of the foot is, for example, rotation centering on the knee.

Here, the norm of the angular velocities of the three axes is a value obtained by summing squares of the respective angular velocities with respect to the X axis, the Y axis, and the Z axis and taking a square root of a value of the sum. The difference in the norm is, for example, for the norm acquired from measurement values obtained at predetermined time intervals for each predetermined time, a difference between a norm at a certain time point and a norm in the past by the predetermined time. The predetermined time may be, for example, 1 [millisecond].

In the procedure P2, the server device 2 traces back the time from the point of the start of lifting and segments a point having a first predetermined time length before the point of the start of lifting and set the point as a start point of a segmentation section. The first predetermined time length is not particularly limited and, for example, one second or the like may be used.

The server device 2 segments a point having a second predetermined time length after the point of the start of lifting as an end point of the segmentation section. The second predetermined time length is not particularly limited and for example, twenty seconds or thirty seconds may be used.

Accordingly, a segmentation section in which data of lifting in the predetermined time is segmented is set. In this example, the predetermined time in which the data of lifting is segmented is equivalent to the time length of the segmentation section and specifically is a sum of the first predetermined time length and the second predetermined time length.

Here, in this example, a time section of the first predetermined time length before the point of the start of lifting may be used as, for example, a stationary section of the user 51 in calibration of posture calculation.

In the processing T2 illustrated in FIG. 7, the server device 12 calculates the speed and the posture of the measurement device 11.

In the calculation, the server device 12 calculates the speed and the posture from acceleration and angular velocity for a data section in which the data of lifting is obtained.

In the processing T3 and the processing T4 illustrated in FIG. 7, the server device 12 estimates a below-knee length from the body height of the user 51 and calculates an angle of the foot based on a result of the estimation.

In the present embodiment, the angle of the foot represents a tilt from the below-knee part to the foot, that is, a tilt of a portion from the below-knee part to the foot.

For example, in a configuration including a foot angle calculation function of calculating an angle of the foot and a below-knee length estimation function of estimating a below-knee length, the foot angle calculation function may input information concerning a body height to the below-knee length estimation function and the below-knee length estimation function may output information concerning the below-knee length corresponding to the body height to the foot angle calculation function.

Further, in the present embodiment, in the processing T3 and the processing T4 illustrated in FIG. 7, the server device 12 calculates the speed of the foot in the direction of gravity based on a result of estimating the below-knee length from the body height of the user 51.

For example, in a configuration including a foot speed calculation function of calculating the speed of the foot in the direction of gravity and a below-knee length estimation function of estimating a below-knee length, the foot speed calculation function may input information concerning a body height to the below-knee length estimation function and the below-knee length estimation function may output information of a below-knee length corresponding to the body height to the foot speed calculation function.

Here, when both of the foot angle calculation function and the foot speed calculation function are provided, processing of estimating a below-knee length from the body height of the user 51 may be performed, for example, in one of the functions and information concerning a result of the processing may be used in the other.

The speed of the foot in the direction of gravity may be calculated based on, for example, the speed and the posture of the below-knee part and the below-knee length.

In the present embodiment, in the calculation of the speed of the foot in the direction of gravity, a part from the below-knee part to the foot is defined as a rigid body. That is, when the part from the below-knee part to the foot is defined as the rigid body, since angular velocity is the same and a rotation amount is the same, the speed and the posture of the foot can be calculated by calculating the acceleration of the foot from the below-knee length.

In the estimation of the timing of the ball touch in the processing T3 illustrated in FIG. 7, the estimation unit 132 estimates, based on the tilt from the below-knee part to the foot, timing when the user 51 would have touched the ball during the lifting.

In this example, the estimation unit 132 determines, as a point of the ball touch, a point at timing when the foot of the user 51 rises.

In the example illustrated in FIG. 6B, the point of the timing of each of the second time t2, the fourth time t4, the sixth time t6, the eighth time t8, and the tenth time t10 is determined as the point of the ball touch.

In general, a method of detecting a point of a ball touch based on an impact applied to the sensor using the norm of acceleration is also conceivable. However, in this method, for example, the impact applied to the sensor sometimes cannot be detected in the below-knee part. The impact is sometimes less easily applied to the sensor depending on a way of lifting.

Thus, in the present embodiment, the timing of the ball touch in the lifting is estimated based on the angle of the foot representing the tilt from the below-knee part to the foot. When this estimation is performed, the norm of acceleration may be further used.

In the processing T5 illustrated in FIG. 7, the server device 12 evaluates lifting.

In this example, the evaluation unit 133 evaluates the following first to third evaluation matters from the timing of the ball touch and the tilt from the below-knee part to the foot.

For example, each of the evaluation matters may evaluated using scores stepwise. As an example, evaluation of scores in ten grades may be performed at one point interval with the worst score set as one point and with the best score set as ten points.

As an example, data of lifting of a high-level player in soccer may be collected and, based on the data, a score in the case of a numerical value close to a numerical value of the data of the player may set as ten points and a score may be set to be gradually lower as a numerical value becomes worse compared with the numerical value of the data of the player.

In the evaluation of the lifting, schematically, whether stable lifting has been successfully performed is evaluated.

The first evaluation matter is an evaluation matter based on variation in a time interval of a ball touch.

Schematically, evaluation is good when the ball touch can be performed at a constant time interval and evaluation is better when the time interval of the ball touch is closer to the constant time interval. That is, when the time interval of the ball touch in the lifting is close to the constant time interval, the lifting is considered to be stable.

The second evaluation matter is an evaluation matter based on variation in a foot lifting angle that is an angle at the time when the foot is lifted.

Schematically, evaluation is good when foot lifting angles in a plurality of times of lifting are the same angle and evaluation is better when the foot lifting angles in a plurality of times of lifting are closer to the same angle. That is, when the foot lifting angle in a plurality of times of lifting is closer to the same angle, the lifting is considered to be stable.

The third evaluation matter is an evaluation matter based on variation in foot lifting speed that is speed at the time when the foot is lifted.

Schematically, maximum speed, average speed, and median speed of the foot-lifting speed are calculated in each one time of a ball touch in lifting. For a plurality of times of ball touches in lifting, variation in the maximum speed, variation in the average speed, and variation in the median speed are calculated and the smaller the variations, the better the evaluation. That is, in a plurality of ball touches in lifting, when the variation in the maximum speed, the average speed, and the median speed of the foot-lifting speed is smaller, the lifting is considered to be more stable.

Here, as the evaluation of the variation in the maximum speed, the variation in the average speed, and the variation in the median speed, for example, at least one of these variations may be evaluated.

When two or more variations among the variation in the maximum speed, the variation in the average speed, and the variation in the median speed are evaluated, for example, the evaluation may be performed individually for each of the two or more variations or may be performed collectively for the two or more variations by setting one evaluation indicator calculated from the two or more variations.

Here, in this example, the first evaluation matter to the third evaluation matter are explained. However, as another example, only some of the first evaluation matter to the third evaluation matter may be used for the evaluation and the other evaluation matter may be used for the evaluation.

In the processing T6 illustrated in FIG. 7, the server device 12 generates the evaluation report K2.

In this example, the report generation unit 135 generates the evaluation report K2 according to levels of evaluation results of the first to third evaluation matters.

The report generation unit 135 may generate the evaluation report K2 using information concerning the advice generated by the advice unit 134.

Here, for example, the advice unit 134 may generate the information concerning the advice corresponding to levels of the evaluation results of the first to third evaluation matters. For example, the generation may be automatically performed or may be supported by operation of the coach or the like of the user 51.

As an example, information concerning advice comments corresponding to the levels of the evaluation results of the first to third evaluation matters may be prepared in advance as correspondence information of a table format or the like and stored in the storage unit 114. In the correspondence information, the levels and the information concerning the advice comments are associated.

In this case, the advice unit 134 refers to the advice comments corresponding to the levels according to the levels of the evaluation results of the first to third evaluation matters based on the correspondence information and generates information concerning advice based on the advice comment.

Further, the advice comment can be edited by the coach or the like of the user 51.

For example, the advice unit 134 may have a function of machine learning and, when the advice comment is edited, may learn a correspondence relationship between the edited advice comment and the levels of the evaluation results of the first to third evaluation matters and, based on a result of the learning, for the next and subsequent measurement data K1, generate information concerning advice using information concerning a learned advice comment based on the levels of the evaluation results of the first to third evaluation matters.

Here, in the machine learning, the advice unit 134 may learn, for example, information concerning a table that associates the levels of the evaluation results of the first to third evaluation matters and any ones of a plurality of types of fixed advice comments may be learned.

As explained above, in the motion evaluation system 1 and the control method therefor according to the present embodiment, even when it is difficult to attach a sensor to a foot of a subject, it is possible to perform evaluation corresponding to timing when the foot of the subject has come into contact with a target object. In the present embodiment, the target object is the soccer ball 61.

In the motion evaluation system 1 and the control method therefor according to the present embodiment, for example, it is possible to estimate timing when the foot of the subject has come into contact with the target object based on output from a sensor attached below the knee of the subject and perform evaluation concerning the estimated timing.

In the motion evaluation system 1 and the control method therefor according to the present embodiment, for example, since a sensor does not have to be attached the ball 61, a motion can be evaluated without a plurality of sensors including a sensor attached to the subject and a sensor attached to the ball 61.

For example, when the sensor attached to the subject and the sensor attached to the ball 61 are used, a large processing load are sometimes applied to, for example, ensure time synchronization between these sensors, combine output values from these sensors, and the like.

Here, in the present embodiment, the configuration according to the present embodiment is applied to soccer. However, the same configuration as the configuration in the present embodiment may be applied to other sports.

As an example, in the present embodiment, the evaluation of the motion of the user 51 lifting the soccer ball 61 is explained above. However, as another example, the same configuration as the configuration in the present embodiment may be applied to evaluation of a motion at the time when lifting a ball of another sport.

Examples of the other sport include rugby.

Configuration examples according to the present embodiment are explained.

As a configuration example, a control method for the motion evaluation system 1 has the following configuration.

The motion evaluation system 1 includes a sensor attached to a predetermined wearing position below a knee of a subject and the server device 12 that generates the evaluation report K2 based on a detection result of the sensor.

The control method for the motion evaluation system 1 includes a first step to a fourth step.

In the first step, the control method causes the sensor to detect motion information indicating a motion below the knee of the subject.

In the second step, the control method causes the sensor to transmit the motion information to the server device 12.

In the third step, the control method causes the server device 12 to estimate, based on the received motion information, timing when the foot of the subject has come into contact with a target object.

In the fourth step, the control method causes the server device 12 to evaluate the estimated timing.

Therefore, in the control method for the motion evaluation system 1, for example, even when it is difficult to attach the sensor to the foot of the subject, it is possible to perform the evaluation corresponding to the timing when the foot of the subject has come into contact with the target object.

Here, in the present embodiment, the user 51 is an example of the subject.

In the present embodiment, a sensor provided in the measurement device 11 is an example of the sensor. The number of sensors may be one or may be plural.

The predetermined wearing position may be various positions and may be, for example, the position of the below-knee part illustrated in FIG. 3A, the first wearing position E1 illustrated in FIG. 3C, the second wearing position E2 illustrated in FIG. 3D, or the like.

In the present embodiment, information indicating a motion of the user 51 lifting the ball 61 is an example of the motion information.

In the present embodiment, as an example, motion information indicating a motion at the predetermined wearing position below the knee of the subject may be used as the motion information indicating the motion below the knee of the subject. In this case, the motion information indicating the motion at the predetermined wearing position may be, for example, information included in the measurement data K1 at the time when the user 51 lifts the ball 61 or information obtained by calculation or the like based on the information. Here, the measurement data K1 is, for example, data measured for the predetermined wearing position of the sensor.

As another example, motion information indicating a motion at a position below the knee of the subject and other than the predetermined wearing position may be used as the motion information indicating the motion below the knee of the subject. In this case, the motion information indicating the motion at the position other than the predetermined wearing position may be obtained by calculation or the like based on, for example, the measurement data K1.

In the present embodiment, the movement of the foot at the time when the user 51 lifts the ball 61 is an example of the movement of the foot of the subject and information indicating a motion relating to the movement of the foot is acquired as the motion information.

As a configuration example, a control method for the motion evaluation system 1 has the following configuration.

In the third step, the control method causes the server device 12 to estimate a tilt from the below-knee part to the foot with respect to the direction of gravity based on the received motion information and estimate timing when the foot of the subject has come into contact with the target object based on the estimated tilt.

Therefore, in the control method for the motion evaluation system 1, for example, the evaluation can be performed according to the tilt from the below-knee part to the foot.

Here, the tilt from the below-knee part to the foot with respect to the direction of gravity may be represented as, for example, an angle of the foot.

As a configuration example, a control method for the motion evaluation system 1 has the following configuration.

In the fourth step, the control method causes the server device 12 to evaluate variation in an angle in a plurality of specific motions from a tilt from the below-knee part to the foot with respect to the direction of gravity.

Therefore, in the control method for the motion evaluation system 1, for example, it is possible to evaluate variation in an angle of foot lifting as in the second evaluation matter.

In this case, a motion of foot lifting is an example of the specific motion.

The angle of foot lifting may correspond to, for example, a posture below the knee. As the posture below the knee, for example, a posture at the predetermined wearing position below the knee may be used or a posture at a position other than the predetermined wearing position below the knee may be used.

As a configuration example, the control method for the motion evaluation system 1 includes a fifth step.

In the fifth step, the control method causes the server device 12 to output advice corresponding to the evaluation.

Therefore, in the control method for the motion evaluation system 1, for example, the advice can be automatically generated.

As a configuration example, a control method for the motion evaluation system 1 has the following configuration.

In the fourth step, the control method causes the server device 12 to evaluate, from an interval of the specific motion, whether the specific motion is performed at a constant interval.

Therefore, in the control method for the motion evaluation system 1, for example, it is possible to evaluate variation in a movement of the specific motion as in the first evaluation matter.

Here, the interval is, for example, a temporal interval.

As a configuration example, a control method for the motion evaluation system 1 has the following configuration.

In the third step, the control method causes the server device 12 to estimate the speed of the foot in the direction of gravity based on the motion information.

In the fourth step, the control method causes the server device 12 to evaluate variation in the speed of the foot in the direction of gravity.

Therefore, in the control method for the motion evaluation system 1, for example, it is possible to evaluate speed at the time when the foot is raised as in the third evaluation matter.

Here, the speed of the foot in the direction of gravity may correspond to, for example, the speed below the knee. As the speed below the knee, for example, the speed at the predetermined wearing position below the knee may be used or the speed at a position other than the predetermined wearing position below the knee may be used.

As a configuration example, the control method for the motion evaluation system 1 includes a sixth step.

In the sixth step, the control method causes the server device 12 to acquire length information concerning the length from the below-knee part to the foot of the subject.

In the third step, the control method causes the server device 12 to estimate the speed of the foot in the direction of gravity based on the motion information and the length information.

Therefore, in the control method for the motion evaluation system 1, for example, the speed of the foot in the direction of gravity can be estimated considering the length from the below-knee part to the foot of the subject.

Here, in the present embodiment, information concerning the below-knee length of the user 51 is an example of the length information concerning the length from the below-knee part to the foot of the subject.

As a configuration example, a control method for the motion evaluation system 1 has the following configuration.

In the sixth step, the control method causes the server device 12 to receive information concerning the body height of the subject.

In the sixth step, the control method causes the server device 12 to acquire length information based on the body height of the subject.

Therefore, in the control method for the motion evaluation system 1, for example, the length from the below-knee part to the foot of the subject is acquired based on the body height of the subject.

As a configuration example, a control method for the motion evaluation system 1 has the following configuration.

In the fourth step, the control method causes the server device 12 to specify a feature point of the motion information from the motion information detected by the sensor and extract the motion information.

Therefore, in the control method for the motion evaluation system 1, for example, an evaluation section can be automatically extracted from data detected by the sensor.

Here, in the present embodiment, the point of the start of the lifting specified in the processing T1 illustrated in FIG. 7 is an example of the feature point of the motion information.

Any other feature point may be used as the feature point of the motion information.

The extraction of information may be called, for example, segmentation of information.

As a configuration example, a control method for the motion evaluation system 1 has the following configuration.

The motion evaluation system 1 includes a sensor attached to a predetermined wearing position below a knee of a subject and the server device 12 that generates the evaluation report K2 based on a detection result of the sensor.

A control method for the motion evaluation system 1 includes a step of causing a sensor to detect motion information indicating a motion below a knee of a subject, a step of causing the server device 12 to estimate, based on the motion information received from the sensor, timing when a foot of the subject has come into contact with a target object, and a step of causing the server device 12 to perform evaluation concerning the estimated timing.

Therefore, in the control method for the motion evaluation system 1, for example, even when it is difficult to attach the sensor to the foot of the subject, it is possible to perform the evaluation corresponding to the timing when the foot of the subject has come into contact with the target object.

As a configuration example, a control method for a computer has the following configuration.

The control method for the computer includes the following steps.

The control method for the computer includes a step of causing the computer to acquire motion information indicating a movement of below a knee of a subject from a sensor attached to a predetermined wearing position below the knee of the subject.

The control method for the computer includes a step of causing the computer to estimate, based on the acquired motion information, timing when the foot of the subject has come into contact with a target object.

The control method for the computer includes a step of causing the computer to evaluate the estimated timing.

Therefore, in the control method for the computer, for example, even when it is difficult to attach the sensor to the foot of the subject, it is possible to perform evaluation corresponding to the timing when the foot of the subject has come into contact with the target object.

Here, the computer may be, for example, a computer configuring the server device 12.

As a configuration example, a program has the following configuration.

The program is a program for causing a computer to execute the steps explained above.

Therefore, in the program, for example, even when it is difficult to attach the sensor to the foot of the subject, it is possible to perform evaluation corresponding to the timing when the foot of the subject has come into contact with the target object.

As a configuration example, the motion evaluation system 1 has the following configuration.

The motion evaluation system 1 includes a sensor that is attached to a predetermined wearing position below a knee of a subject and detects motion information indicating a motion below the knee of the subject and the server device 12 that receives the motion information from the sensor, estimates, based on the received motion information, timing when a foot of the subject has come into contact with a target object, and performs evaluation concerning the estimated timing.

Therefore, in the motion evaluation system 1, for example, even when it is difficult to attach the sensor to the foot of the subject, it is possible to perform evaluation corresponding to the timing when the foot of the subject has come into contact with the target object.

A program for implementing a function of any constituent unit in any device explained above may be recorded in a computer-readable recording medium and executed by causing a computer system to read the program. It is assumed that the "computer system" referred to here includes an operating system or hardware such as peripheral equipment. The "computer-readable recording medium" is a portable medium such as a flexible disc, a magneto-optical disc, a read only memory (ROM), or a compact disc (CD)-ROM or a storage device such as a hard disk incorporated in the computer system. It is assumed that the "computer-readable recording medium" includes a recording medium that retains a program for a certain period of time like a volatile memory on the inside of the computer system serving as a server or a client when the program is transmitted via a network such as the Internet or a communication line such as a telephone line. The volatile memory may be a RAM. The recording medium may be a non-transitory recording medium.

The program explained above may be transmitted from a computer system in which the program is stored in a storage device or the like to another computer system via a transmission medium or by a transmission wave in the transmission medium. The "transmission medium" for transmitting the program refers to a medium having a function of transmitting information like a network such as the Internet or a communication line such as a telephone line.

The program explained above may be a program for implementing some of the functions explained above. The program explained above may be a program that can implement the functions explained above in combination with a program already recorded on the computer system, a so-called differential file. The differential file may be called differential program.

The function of any constituent unit in any device explained above may be implemented by a processor. The kinds of processing in the embodiment may be implemented by a processor that operates based on information such as a program and a computer-readable recording medium that stores the information such as the program. In the processor, the functions of the units may be implemented by individual hardware or the functions of the units may be implemented by integrated hardware. The processor may include hardware and the hardware may include at least one of a circuit that processes a digital signal and a circuit that processes an analog signal. The processor may be configured using one or both of one or a plurality of circuit devices implemented on a circuit board and one or a plurality of circuit elements. An integrated circuit (IC) or the like may be used as the circuit device and a resistor, a capacitor, or the like may be used as the circuit element.

The processor may be a CPU. However, the processor is not limited to the CPU, and various processors such as a graphics processing unit (GPU) or a digital signal processor (DSP) may be used. The processor may be a hardware circuit by an application specific integrated circuit (ASIC). The processor may include a plurality of CPUs or may include a hardware circuit by a plurality of ASICs. The processor may include a combination of a plurality of CPUs and a hardware circuit by a plurality of ASICs. The processor may include one or more of an amplifier circuit, a filter circuit, and the like that process an analog signal.

While the embodiment is explained in detail above with reference to the drawings, a specific configuration is not limited to the embodiment and includes design and the like in a range not departing from the gist of the present disclosure.

### Appendices

Configuration examples 1 to 13 are explained below.

A lower-order configuration example may or may not be applied to a higher-order configuration example.

A lower-order configuration example applicable to any one of two or more higher-order configuration examples may be applied to any configuration example among the two or more higher-order configuration examples and, when there are two or more application examples in this way, a configuration example lower in order than the lower-order configuration example may be applied to any application example among the two or more application examples.

### Configuration Example 1

A control method for a motion evaluation system including a sensor attached to a predetermined wearing position below a knee of a subject and a server device configured to generate an evaluation report based on a detection result of the sensor, the control method including: a first step of causing the sensor to detect motion information indicating a motion below the knee of the subject; a second step of causing the sensor to transmit the motion information to the server device; a third step of causing the server device to estimate, based on the received motion information, timing when a foot of the subject came into contact with a target object; and a fourth step of causing the server device to perform evaluation concerning the estimated timing.

### Configuration Example 2

The control method for the motion evaluation system described in the configuration example 1 wherein, in the third step, the control method causes the server device to estimate, based on the received motion information, a tilt from a below-knee part to the foot with respect to a direction of gravity and estimate, based on the estimated tilt, timing when the foot of the subject came into contact with a target object.

### Configuration Example 3

The control method for the motion evaluation system described in the configuration example 2, wherein, in the fourth step, the control method causes the server device to perform, from the tilt, evaluation concerning variation in an angle in a plurality of specific motions.

### Configuration Example 4

The control method for the motion evaluation system described in the configuration example 3, further including a fifth step of causing the server device to output advice corresponding to the evaluation.

Note that, in the configuration example 4, the advice corresponding to the evaluation in the configuration example 3 is output. However, the same configuration as the configuration example 4 may be applied to, for example, any one or more of the evaluation in the configuration example 1, evaluation in a configuration example 5, and evaluation in a configuration example 6.

### Configuration Example 5

The control method for the motion evaluation system described in the configuration example 4, wherein, in the fourth step, the control method causes the server device to perform, from an interval of the specific motion, evaluation concerning whether the specific motion is performed at a constant interval.

### Configuration Example 6

The control method for the motion evaluation system described in any one of the configuration example 1 to the configuration example 5, wherein in the third step, the control method causes the server device to estimate, based on the motion information, speed of the foot in a direction of gravity, and in the fourth step, the control method causes the server device to perform evaluation concerning variation in the speed of the foot in the direction of gravity.

### Configuration Example 7

The control method for the motion evaluation system described in the configuration example 6, further including a sixth step of causing the server device to acquire length information concerning length from a below-knee part to the foot of the subject, wherein in the third step, the control method causes the server device to estimate, based on the motion information and the length information, speed of the foot in the direction of gravity.

### Configuration Example 8

The control method for the motion evaluation system described in the configuration example 7, wherein in the sixth step, the control method causes the server device to receive information concerning a body height of the subject, and in the sixth step, the control method causes the server device to acquire the length information based on the body height of the subject.

### Configuration Example 9

The control method for the motion evaluation system described in any one of the configuration example 1 to the configuration example 8, wherein, in the fourth step, the control method causes the server device to specify a feature point of the motion information from the motion information detected by the sensor and extract the motion information.

### Configuration Example 10

A control method for a motion evaluation system including a sensor attached to a predetermined wearing position below a knee of a subject and a server device configured to generate an evaluation report based on a detection result of the sensor, the control method including: causing the sensor to detect motion information indicating a motion below the knee of the subject; causing the server device to estimate, based on the received motion information, timing when a foot of the subject came into contact with a target object; and causing the server device to perform evaluation concerning the estimated timing.

### Configuration Example 11

A control method for a computer, the control method including: causing the computer to acquire motion information indicating a motion below a knee of the subject from a sensor attached to a predetermined wearing position below the knee of the subject; causing the computer to estimate, based on the acquired motion information, timing when a foot of the subject came into contact with a target object; and causing the computer to perform evaluation concerning the estimated timing.

### Configuration Example 12

A non-transitory computer-readable storage medium storing a program for causing a computer to execute the steps described in the configuration example 11.

### Configuration Example 13

A motion evaluation system including: a sensor attached to a predetermined wearing position below a knee of a subject and configured to detect motion information indicating a motion below the knee of the subject; and a server device configured to receive the motion information from the sensor, estimate, based on the received motion information, timing when a foot of the subject came into contact with a target object, and perform evaluation concerning the estimated timing.

What is claimed is:

1. A control method for a motion evaluation system including a sensor attached to a predetermined wearing position below a knee of a subject and a server device configured to generate an evaluation report based on a detection result of the sensor, the control method comprising:
a first step of causing the sensor to detect motion information indicating a motion below the knee of the subject;
a second step of causing the sensor to transmit the motion information to the server device;
a third step of causing the server device to estimate, based on the received motion information, timing when a foot of the subject came into contact with a target object; and
a fourth step of causing the server device to perform evaluation concerning the estimated timing.

2. The control method for the motion evaluation system according to claim 1 wherein, in the third step, the control method causes the server device to estimate, based on the received motion information, a tilt from a below-knee part to the foot with respect to a direction of gravity and estimate, based on the estimated tilt, timing when the foot of the subject came into contact with a target object.

3. The control method for the motion evaluation system according to claim 2, wherein, in the fourth step, the control method causes the server device to perform, from the tilt, evaluation concerning variation in an angle in a plurality of specific motions.

4. The control method for the motion evaluation system according to claim 3, further comprising a fifth step of causing the server device to output advice corresponding to the evaluation.

5. The control method for the motion evaluation system according to claim 4, wherein, in the fourth step, the control method causes the server device to perform, from an interval of the specific motion, evaluation concerning whether the specific motion is performed at a constant interval.

6. The control method for the motion evaluation system according to claim 5, wherein
in the third step, the control method causes the server device to estimate, based on the motion information, speed of the foot in the direction of gravity, and
in the fourth step, the control method causes the server device to perform evaluation concerning variation in the speed of the foot in the direction of gravity.

7. The control method for the motion evaluation system according to claim 6, further comprising a sixth step of causing the server device to acquire length information concerning length from a below-knee part to the foot of the subject, wherein
in the third step, the control method causes the server device to estimate, based on the motion information and the length information, speed of the foot in the direction of gravity.

8. The control method for the motion evaluation system according to claim 7, wherein
in the sixth step, the control method causes the server device to receive information concerning a body height of the subject, and
in the sixth step, the control method causes the server device to acquire the length information based on the body height of the subject.

9. The control method for the motion evaluation system according to claim 8, wherein, in the fourth step, the control method causes the server device to specify a feature point of the motion information from the motion information detected by the sensor and extract the motion information.

10. A control method for a computer, the control method including:
causing the computer to acquire motion information indicating a motion below a knee of the subject from a sensor attached to a predetermined wearing position below the knee of the subject;
causing the computer to estimate, based on the acquired motion information, timing when a foot of the subject came into contact with a target object; and
causing the computer to perform evaluation concerning the estimated timing.

11. A non-transitory computer-readable storage medium storing a program for causing a computer to execute the steps described in claim 10.

12. A motion evaluation system comprising:
a sensor attached to a predetermined wearing position below a knee of a subject and configured to detect motion information indicating a motion below the knee of the subject; and
a server device configured to receive the motion information from the sensor, estimate, based on the received motion information, timing when a foot of the subject came into contact with a target object, and perform evaluation concerning the estimated timing.
